(19) United States
(12) Patent Application Publication
(10) Pub. No.: US 2001/0053689 A1
(43) Pub. Date: Dec. 20, 2001

(54) Mobile radio communication apparatus

(76) Inventors: Ippo Aoki, Fuchu-shi (JP); Akira Ishikura, Kawasaki-shi (JP); Shinya Takahashi, Hino-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 09/879,191

(22) Filed: Jun. 13, 2001

(30) Foreign Application Priority Data
Jun. 14, 2000 (JP) 2000-178158

(51) Int. Cl. H04M 3/42

(52) U.S. Cl. 455/414; 455/512

(57) ABSTRACT

Disclosed herein is a mobile radio communication apparatus that includes a memory. The memory stores, for each area in which base stations (BSs) are operating, SID, priority data items representing priorities assigned to BSs, and information representing types of service. The contents of the memory are referred to, thereby to determine whether a BS seized is offering the type of service the user has requested. If the BS seized is one that does not offer the desired type of service, one of the other BSs offering the desired type of service in the area in which the BS seized is operating is seized in accordance with the priority data items. Thus, the apparatus can seize a BS offering service the user wants to utilize, even if it has already seized another BS which does not offer this service and has therefore come into an idle state.

### CROSS-REFERENCE TO RELATED APPLICATIONS

This application is based upon and claims the benefit of priority from the prior Japanese Patent Application No. 2000-178158, filed Jun. 14, 2000, the entire contents of which are incorporated herein by reference.

### BACKGROUND OF THE INVENTION

1. Field of the Invention

The present invention relates to a mobile radio communication apparatus that performs a control process to seize the base stations. More particularly, it relates to a mobile radio communication apparatus that can seize at least one of the base stations which offers a service type corresponding to user's request.

2. Description of the Related Art

Every mobile radio communication system comprises base stations, mobile radio communication apparatuses, each mobile apparatus connected to one of the base stations over a radio channel. In a mobile radio communication system, any mobile radio communication apparatus starts a control process when its power switch is closed. Upon finishing the control process, the apparatus seizes the base station and takes an idle state. Thereafter, it can receive calls from the base station. While remaining in the idle state, the apparatus can transmit the user's call origination to the base station.

Generally, the areas covered by base stations overlap one another, and the base stations offer same service at different charges. The mobile radio communication apparatus stores information representing a priority corresponding to each base station. Priority is allocated to each base station in accordance with the charge at which they provide the service. More precisely, the lower the charge, the higher the priority. Thus, the apparatus tries to seize, first the base station whose charge is the lowest, next the base station whose charge is the second lowest, and so forth.

In the mobile radio communication systems recently developed, some base stations offer the telecommunication only. By contrast, the other base stations give, in addition to telecommunication, short-message service (SMS) corresponding to electronic mail service, data communication service, wireless application protocol (WAP) service, which is to receive and browse information from the Internet into personal computers. Assume that a mobile radio communication apparatus seizes the base station offering telecommunication at the lowest charge and that this base station does not offer any other service. Then, the user cannot utilize any service other than telecommunication, no matter how many times the user sends the request to the seized base station. That is, the user cannot receive other service unless the apparatus moves and seizes any base station which offers the other service.

Once the conventional mobile radio communication apparatus has seized a base station which offers telecommunication only and has therefore taken the idle state, it can no longer seize any other base station providing the other service the user wishes to utilize. Consequently, the user cannot utilize the other service from the other base stations.

### BRIEF SUMMARY OF THE INVENTION

The present invention has been made in view of the foregoing. An object of the invention is to provide a mobile radio communication apparatus that can seize a base station which offers service the user wants to utilize, even after it has seized another base station which does not offer this service and has therefore taken an idle state.

According to a first aspect of the invention, there is provided a mobile radio communication apparatus for use in a mobile radio communication system which includes base stations, mobile radio communication apparatuses to be connected to the base stations over radio channels, and in which each of the base stations broadcasts a system ID number for identifying the base station, the apparatus comprising:

memory means for storing system ID numbers, priority data items associated with the system ID numbers and representing priorities assigned to the base stations, each to be used to seize one base station, and information representing types of service the base stations offer in a geographical area in which the base stations are operating;

receiving means for receiving the broadcasted system ID number;

first seizing means for seizing one of the base stations operating in the geographical area and having one of the received system ID numbers, in accordance with the priority data items, and for setting the apparatus in an idle state;

input means for inputting a user's request for a desired type of service while the apparatus remains in the idle state;

decision means for referring to the contents of the memory means when the user's request is input to the input means, thereby determining whether the base station seized is offering the type of service the user has requested; and

second seizing means for seizing, based on the priority data items, one of the base stations offering the desired type of service in the geographical area including the base station seized by the first seizing means, when the decision means determines that the base station seized by the first seizing means does not offer the desired type of service.

According to a second aspect of the invention, there is provided a mobile radio communication apparatus for use in a mobile radio communication system which includes base stations, mobile radio communication apparatuses to be connected to the base stations over radio channels, and in which each of the base stations broadcasts a system ID number for identifying the base station, the apparatus comprising:

memory means for storing system ID numbers and information that is associated with the system ID numbers and represents types of service the base stations offer, in a geographical area in which the base stations are operating;

receiving means for receiving the broadcasted system ID number;

first seizing means for seizing one of the base stations operating in the geographical area and having one of the received system ID numbers, which has prescribed priority, and setting the apparatus in an idle state;

input means for inputting a user's request for a desired type of service while the apparatus remains in the idle state;

decision means for referring to the contents of the memory means when the user's request is input to the input means, thereby determining whether the base station seized is offering the type of service the user has requested; and

second seizing means for seizing one of the base stations offering the desired type of service in the geographical area including the base station seized by the first seizing means, when the decision means determines that the base station seized by the first seizing means does not offer the desired type of service.

According to a third aspect of the invention, there is provided a mobile radio communication apparatus for use in a mobile radio communication system which includes base stations, mobile radio communication apparatuses to be connected to the base stations over radio channels, and in which each of the base stations broadcasts a system ID number for identifying the base station, the apparatus comprising:

memory means for storing system ID numbers, priority data items associated with the system ID numbers and representing priorities assigned to the base stations, each to be used to seize one base station, and information representing types of service the base stations offer in a geographical area;

first seizing means for receiving one of the system ID numbers broadcasted from the base stations, in accordance with the priority data items stored in the memory means, for seizing one of the base stations to which the system ID number received is assigned, and for setting the apparatus in an idle state;

input means for inputting a user's request for a desired type of service while the apparatus remains in the idle state;

decision means for referring to the contents of the memory means when the user's request is input to the input means, thereby determining whether the base station seized is offering the type of service the user has requested; and

second seizing means for seizing one of the base stations offering the desired type of service, when the decision means determines that the base station seized by the first seizing means that does not offer the desired type of service.

According to a fourth aspect of the invention, there is provided a mobile radio communication apparatus for use in a mobile radio communication system which includes base stations, mobile radio communication apparatuses to be connected to the base stations over radio channels, and in which each of the base stations broadcasts a control signal with a system ID number for identifying the base station, the apparatus comprising:

memory means for storing system ID numbers, priority data items representing priorities of the base stations and geographical area data items representing areas in which the base stations are located, the system ID numbers, the priority data items and the geographical area data items being mutually associated;

receiving means for receiving the broadcasted control signal, the signal including the system ID number assigned to a base station;

detecting means for detecting the system ID number, from the received control signals;

area-designating means for designating, based on the detected system ID number, a geographical area data item representing an area in which the base station connected to the mobile radio communication apparatus is located;

seizing means for detecting the system ID number assigned to the base station having a higher priority in the area, based on the geographical area data item designated by the area-designating means, for seizing the base station, and for setting the apparatus in an idle state;

input means for inputting a user's request for a desired type of service while the apparatus remains in the idle state;

decision means for referring to the contents of the memory means when the user's request is input to the input means, thereby determining whether the base station seized is offering the type of service the user has requested; and

control means for causing the seizing means to seize, based on the priority data items, one of the base stations offering the desired type of service in the geographical area including the base station seized by the seizing means, when the decision means determines that the base station seized by the seizing means does not offer the desired type of service.

According to a fifth aspect of the invention, there is provided a mobile radio communication apparatus for use in a mobile radio communication system which includes base stations, mobile radio communication apparatuses to be connected to the base stations over radio channels, and in which each of the base stations broadcasts a system ID number for identifying the base station, the apparatus comprising:

setting means for seizing one of the base stations in accordance with the broadcasted system ID numbers and setting the apparatus in an idle state;

input means for inputting a user's request for a desired type of service while the apparatus remains in the idle state; and

control means for causing the setting means to seize a base station offering the desired type of service which is described in the user's request input to the input means.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a function block diagram of a mobile radio communication apparatus that is an embodiment of the invention;

FIG. 2 is a flowchart explaining the control process performed in the apparatus of FIG. 1 until the apparatus comes into an idle state;

FIG. 3 is an acquisition table that is referred to in some steps shown in the flowchart of FIG. 2;

FIG. 4 is a system table that is referred to in some steps shown in the flowchart of FIG. 2;

FIG. 5 is a diagram illustrating how the mobile radio communication apparatus, which is the embodiment of the invention, seizes some base stations;

FIG. 6 is a flowchart explaining how the mobile radio communication apparatus, or the embodiment, performs a control process to seize base stations when it receives an SMS request after it has taken the idle state; and

FIG. 7 is a diagram depicting the base stations to which a mobile radio communication apparatus according to the invention can be connected.

### DETAILED DESCRIPTION OF THE INVENTION

An embodiment of the present invention will be described, with reference to the accompanying drawings.

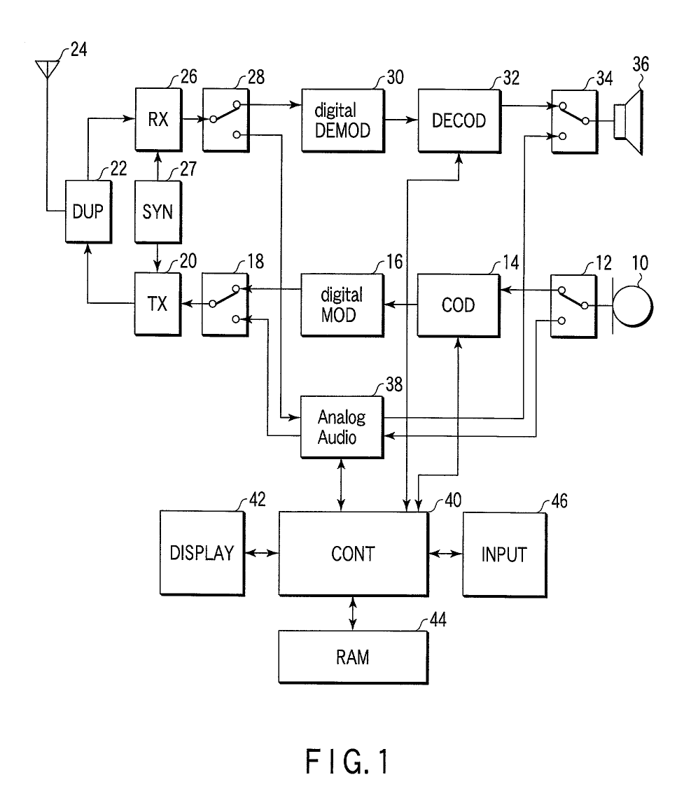

The embodiment is a mobile radio communication apparatus, which will be described with reference to FIGS. 1 to 7. FIG. 1 is a function block diagram. As shown in FIG. 1, the apparatus comprises a microphone 10, a switch 12, an encoder 14, a digital modulator 16, a switch 18, a radio transmitter 20, a duplexer 22, and an antenna 24, a radio receiver 26, and a synthesizer 27, a switch 28, a digital demodulator 30, a decoder 32, a switch 34, and a speaker 36.

An audio signal the microphone 10 has output is supplied via the switch 12 to the encoder 14. The encoder 14 converts the audio signal to a digital signal. The digital signal is compressed and supplied to the digital modulator 16. The digital modulator 16 modulates the digital signal, which is supplied via the switch 18 to the radio transmitter 20. The radio transmitter 20 converts the modulated digital signal to a high-frequency signal in accordance with a local signal output from the synthesizer 27. The high-frequency signal is amplified to a prescribed power level. The signal thus amplified is supplied to the duplexer 22 and thence to the antenna 24 only. The antenna 24 transmits the amplified signal.

The antenna 24 may receive a high-frequency radio signal transmitted from a base station. This high-frequency radio signal is supplied to the duplexer 22 and then to the radio receiver 26 only. The radio receiver 26 amplifies the supplied signal and converts the amplified signal to a baseband (low-frequency) signal in accordance with a local signal supplied from the synthesizer 27. The baseband signal is supplied via the switch 28 to the digital demodulator 30. The digital demodulator 30 performs digital demodulation on the baseband signal.

The digital signal output from the digital demodulator 30 is supplied to the decoder 32. The decoder 32 decodes the baseband signal to an audio signal, decompresses the decoded baseband signal and converts the decompressed signal to an analog signal. The analog signal is input, through the switch 34, to the speaker 36. The speaker 36 generates sound from the analog signal.

All signal-processing steps described above are carried out when the radio communication is effected in digital mode. How signals are processed when the radio communication is performed in analog mode will be described below. Note that, as shown in FIG. 1, the mobile radio communication apparatus further comprises an analog audio circuit 38, a controller 40, a display 42, a memory (RAM) 44, and an input operation unit 46.

In the analog communication mode, the movable contact is disconnected from the upper stationary contact to the lower stationary contact in the switches 12, 18, 28 and 34, in accordance with instructions given by the controller 40. The switches 12, 18, 28 and 34 are not limited to the type in which a movable contact can physically move between two stationary contacts. Rather, they may be of any other type, if they can electrically connect one component to one of two alternative components.

Now that the movable contact is connected to the lower stationary contact in the switches 12, 18, 28 and 34, the analog signal output from the microphone 10 is input via the switch 12 to the analog audio circuit 38. The analog audio circuit 38 modulates the analog signal. The signal modulated is supplied via the switch 18 to the radio transmitter 20. The radio transmitter 20 converts the signal to a high-frequency signal. The high-frequency signal is supplied via the duplexer 22 to the antenna 24. The antenna 24 transmits the high-frequency signal in the form of a radio signal.

In the analog communication mode, a radio signal transmitted from a base station is supplied from the antenna 24 via the duplexer 22 to the radio receiver 26. The radio receiver 26 converts the radio signal in terms of frequency, to a low-frequency signal. The low-frequency signal is supplied to the analog audio circuit 38. The circuit 38 demodulates the low-frequency signal to an analog signal, which is output via the switch 34 to the speaker 36. The speaker 36 generates sound from the analog signal.

As shown in FIG. 1, the display 42, RAM 44 and input operation unit 46 are connected to the controller 40. To make telecommunication, the user may operate the unit 46, thus inputting data. The display 42 displays the data thus input. Alternatively, the user may use the display 42 and the input operation unit 46 to input character data when the user utilizes the short-message service (SMS).

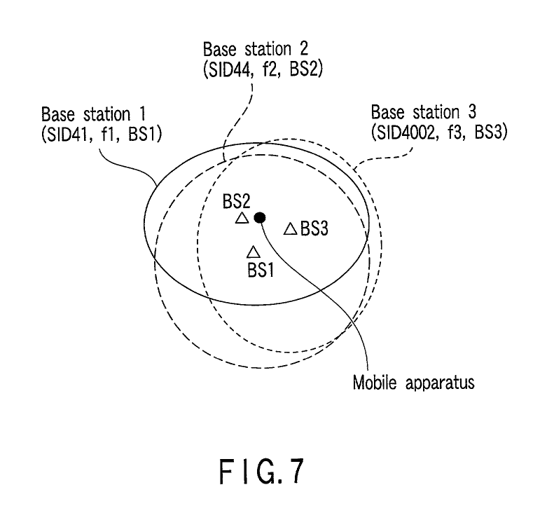

The mobile radio communication system that incorporates the apparatus of FIG. 1 will be described with reference to FIG. 7, to facilitate the understanding of the operation of the apparatus.

As shown in FIG. 7, the mobile radio communication system comprises three base stations 1, 2 and 3 have constructed in a geographical area (GEO). The base stations BS1, BS2 and BS3 cover three service areas, respectively, which overlap one another as is illustrated in FIG. 7. Frequencies f1, f2 and f3 are assigned to the three base stations, respectively. Further, system ID numbers SID41, SID44 and SID4002 are assigned to the three base stations, to identify the base stations.

In the mobile radio communication system of FIG. 7, the mobile radio communication apparatus may perform a prescribed control process to seize a radio signal transmitted from one of the base stations BS1, BS2 and BS3. Once the apparatus has seized the radio signal, it comes into an idle state. Note that a conventional mobile radio communication apparatus, which has seized a base station, cannot switch the base station to another unless it is moved to another place. By contrast, the apparatus according to the present embodiment can switch the base station to another without necessity of being moved to another place. For example, when the user inputs a request for SMS or data communication, the apparatus is disconnected from the base station if the base station offers neither SMS nor data communication and then seizes another base station which provides SMS or data communication, or both. The apparatus is then connected to the other base station and takes an idle state.

How the controller 40 operates to bring the apparatus into the idle state will be explained.

The RAM 44 stores the ID number (SID) and frequency (f) assigned to the base station to which the apparatus was connected when the power switch on the apparatus was closed last. The RAM 44 also stores the ID number SIDH that was assigned to a home base station and included in a carrier with which the user entered a contract. Whenever the apparatus is connected to the home base station, the charge for telecommunication is lowest.

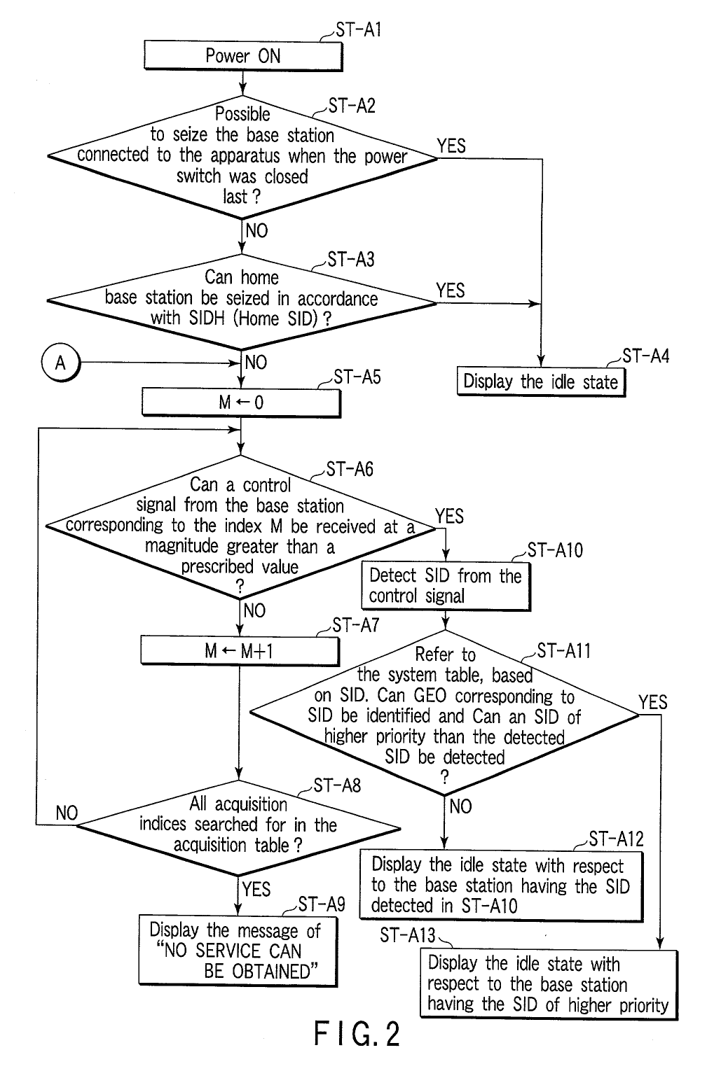

FIG. 2 illustrates the control process the controller 40 performed to bring the mobile radio communication apparatus into an idle state. As FIG. 2 shows, the power switch on the apparatus is turned on (ST-A1). The apparatus tries to seize the last base station to which it was connected when the power switch was turned off last, in accordance with the SID and frequency f, both assigned to this base station and stored in the RAM 44 (ST-A2). If the apparatus seizes the last base station, it takes an idle state, whereby the display 42 displays the idle state (ST-A4). The apparatus can seize the base station if two conditions are satisfied. First, the signal received at a specified frequency has a magnitude equal to or greater than a prescribed value. Second, the desired SID is detected from the signal received.

If the apparatus fails to seize the base station to which it was connected when its power switch was turned off last, it tries to seize the home base station in accordance with the SIDH and the frequency f assigned to the SIDH, both stored in the RAM 44 (ST-A3). If the apparatus seizes the home base station, the control process proceeds to Step ST-A4. In Step ST-A4, the display 42 displays the idle state. If the apparatus fails to seize the home base station, the control process proceeds to Step ST-A5.

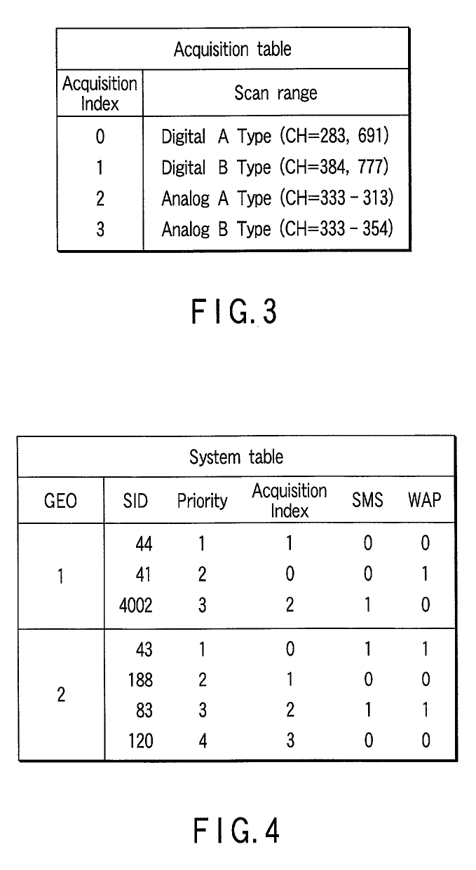

The RAM 44 stores an acquisition table shown in FIG. 3. As FIG. 3 shows, the acquisition table describes acquisition indices and channel numbers CHs corresponding to the acquisition indices, respectively. In Step ST-A5, the apparatus sets the acquisition index at “0”. Then, in Step ST-A6, the mobile radio communication apparatus tries to seize the base stations, one after another, in accordance with the acquisition indices described in the order specified in FIG. 3.

Most mobile radio communication systems installed in the United States are dual systems. In a dual system, a digital system and an analog system are simultaneously in service, so that a mobile radio communication apparatus can be connected to one of the digital system and the analog system. Digital systems are classified into two types. The first type is known as “digital A type”, and the second type as “digital B type”. Similarly, analog systems are classified into two types, i.e., “analog A type” and “analog B type”. In the present embodiment of the invention, four different types of systems can exist in the same geographical area. AS indicated above, each base station belongs to a system of one of these four types.

In Step ST-A6, the apparatus first tries to seize a base station that belongs to the acquisition index 0, i.e., a base station of the digital A type. To allow the apparatus to seize such a base station, the controller 40 sets the receiving frequency for the channel CH283, in accordance with a local signal from the synthesizer 27. The controller 40 then tries to receive a control signal transmitted from the base station over the channel CH283. The controller 40 may fail to receive a control signal having a magnitude equal to or greater than the prescribed value. If so, the controller 40 sets the receiving frequency for the channel CH691 and tries to receive a control signal from the base station over the channel CH691.

If the controller 40 fails to receive the control signal transmitted over the channel CH691 in Step ST-A6, the control process proceeds to Step ST-A7. In Step ST-A7, the apparatus tries to seize a base station that belongs to the acquisition index 1, i.e., a base station of the digital B type. Then, the controller 40 tries to receive a control signal transmitted from the base station over the channel CH384, if the controller 40 fails to receive the control signal transmitted over the channel CH384, and then a control signal transmitted from the base station over the channel CH777. In Step ST-A8, the controller 40 determines whether all acquisition indices have been searched for in the acquisition table. If the controller 40 receives no control signals of the frequencies that correspond to the acquisition indices shown in the acquisition table, the control process proceeds to Step ST-A9. In Step ST-A9, the display 42 displays the message of “NO SERVICE CAN BE OBTAINED”.

If YES in Step ST-A6, the control process proceeds to Step ST-A10. In Step ST-A10, the SID is detected from the control signal the apparatus has received. Next, the control process goes to Step ST-A11, in which the system table stored in the RAM 44 is referred to.

In the mobile communication, particularly in the United States, providers are often merged into a big company or purchase other providers to grow. Consequently, the charging system of the same provider may vary in different geographical areas. Thus, in any area other than the area for which the user has entered a contract with a provider, the types of base stations may not always assume the same priority order as indicated by the acquisition indices shown in the acquisition table of FIG. 3. If the mobile radio communication apparatus seizes base stations in accordance with the acquisition table only, the apparatus may be connected to a base station which offers service at relatively high charges in an area other than the contracted area.

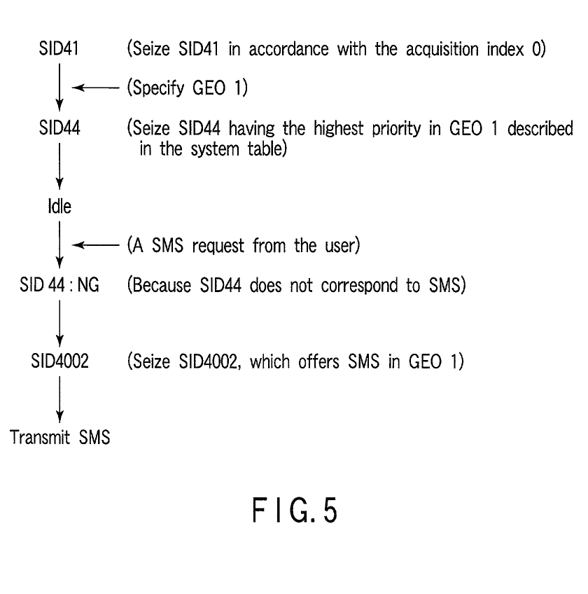

A system table of the type shown in FIG. 4 has been prepared for two or more geographical areas (GEOs), so that the mobile radio communication apparatus may be connected to a base station which offers service at the lower charge in each geographical area.

As shown in FIG. 4, priorities are assigned to base stations, in association with the acquisition indices. The system table of FIG. 4 is applied to the present embodiment. The mobile radio communication apparatus seizes the base stations one after another, in the order of the priority assigned to the base stations. Therefore, the apparatus tries to be connected to the base station whose charge is the lowest, then to the base station whose charge is the second lowest, then to the base station whose charge is the third lowest, and so forth.

As shown in FIG. 4, the system table describes the geographical areas (GEOs), the SIDS of the base stations offering service in the GEOs, the priorities assigned to the base stations, and the acquisition index of each of the base stations. Additionally, the system table describes the types of services (i.e., SMS and WAP) that can be offered or not offered in each geographical area.

Referring back to the flowchart of FIG. 2, the apparatus may seize, in Step ST-A6, the base station identified by the acquisition index M described in the acquisition table. If so, the control process goes to Step ST-A10, in which the SID of the base station seized is detected from the control signal. Then, the control process proceeds to Step ST-A11.

In Step ST-A11, the system table of FIG. 4 is referred to. Then the apparatus tries to identify the GEO that corresponds to the SID detected in Step ST-A10. If the apparatus fails to identify the GEO, the control process proceeds to Step ST-A12. If the apparatus identifies the GEO, the apparatus tries to seize the base station that has an SID with higher priority than any other base station operating in GEO that pertains to the SID detected in Step ST-A10. Since the acquisition indices correspond to the SIDs, the frequency associated with each acquisition index is referred to in the acquisition table and identified. Then, it is determined whether or not the apparatus has received a control signal of the frequency identified. If YES, it is determined whether the SID contained in the control signal is identical to the SID assigned to a base station of higher priority, thereby to seize this base station.

If the SID assigned to the base station of higher priority is detected, the control process proceeds to Step ST-A13. In Step ST-A13, the mobile radio communication apparatus and the base station having the SID detected in Step ST-A11 are set into an idle state, and the display 42 displays the idle state.

The mobile radio communication apparatus may fail to seize the base station of the highest priority in accordance with the system table. If so, the apparatus tries to seize the base station which has the second highest priority listed in the system table.

If the apparatus fails to seize any base station which has priority higher than the base station operating in the same GEO having a base station with the SID detected in Step ST-A10, the control process proceeds to Step ST-A12. In Step ST-A12, the apparatus takes an idle state, after seizing the base station which has the SID detected in Step ST-A10.

The control process described above will be detailed, taking the mobile radio communication system of FIG. 7 for example. As shown in FIG. 7, the mobile radio communication system in a GEO comprises three providers that three base stations 1, 2 and 3 have constructed.

Assume that the apparatus seizes the base station which has SID41 and In Steps ST-A6 and ST-A10, the apparatus first tries to seize a base station that belongs to the acquisition index 0, as is illustrated in FIG. 5.

In this case, the control process proceeds from Step ST-A10 to Step ST-A11. In Step ST-A11, the controller 40 refers to the system table (FIG. 4) stored in the RAM 44, identifying the GEO in which the base station of SID41 is located. Then, the controller 40 tries to seize the base station having higher priority than any other base station operating in the GEO 1 in which the base station of SID41 is located. More precisely, the controller 40 refers to the acquisition table, recognizing the frequency corresponding to acquisition index 1 that is associated with SID44 having the highest priority. Then, the controller 40 searches for the frequency recognized, thereby trying to seize the base station to which SID44 is assigned (Step ST-A11). If the controller detects SID44, the mobile radio communication apparatus takes an idle state (Step ST-A13).

Namely, even if the priority of the base station that the apparatus should seize in the area into which it has moved differs from the priority of the seized base station that is described in the acquisition table, the controller 40 refers to the system table and consequently the apparatus seizes the base station having the highest priority of all base stations listed in the system table.

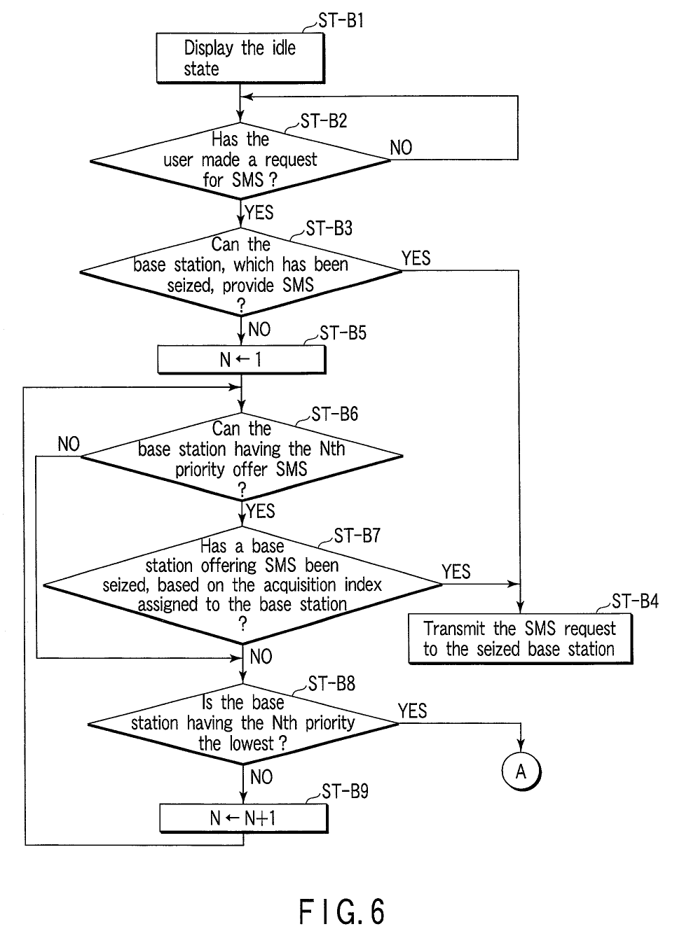

The control process that is performed after the mobile radio communication apparatus takes an idle state in Step ST-A4, ST-A12 or ST-A13 will be described, with reference to the flowchart of FIG. 6.

In Step ST-B1, which is identical to Step ST-A4, ST-A12 and ST-A13, the apparatus comes into an idle state. In Step ST-B2, the controller 40 determines whether the user has made a request for SMS (short-message service). If NO, Step ST-B2 is repeated. If YES, the control process proceeds to Step ST-B3. In Step ST-B3, the controller 40 refers to the system table, determining whether the base station seized by the apparatus can provide SMS. If YES in Step ST-B3, the control process goes to Step ST-B4. In Step ST-B4, the apparatus transmits the SMS request to the base station of the base station. Thereafter, an SMS control process is carried out between the apparatus and the base station.

In Step ST-B3, the controller 40 may determine that the base station cannot provide SMS. If so, the controller 40 refers to the system table, determines whether any other base station can offer SMS, from the SIDs described in the system table, and identifies the base station which can offer SMS and has the highest priority than any other base station which can offer SMS.

More specifically, If NO in Step ST-B3, the control process goes to Step ST-B5. In Step ST-B5, the priority N of the base station the apparatus has seized is set at “1”. Then, the control process proceeds to Step ST-B6.

In Step ST-B6, the controller 40 refers to the system table, determining whether the base station having the Nth priority set in Step ST-B5 provides SMS. If NO, the control process jumps to Step ST-B8. If YES, the control process proceeds to Step ST-B7. In Step ST-B7, a frequency-scan range is specified in accordance with the type of the acquisition index assigned to the base station which can offer SMS, and the apparatus tries to seize this base station.

If YES in Step ST-B7, the control process proceeds to Step ST-B4. If NO in Step ST-B7, the control process goes to Step ST-B8. In Step ST-B8, the controller 40 determines whether the Nth priority is the lowest in the geographical area. If YES, the control process goes to Step ST-A5 (FIG. 2). If NO, the control process proceeds to Step ST-B9 (FIG. 6).

In Step ST-B9, the priority lower N+1 by one unit than the priority N is set. The control process then returns to Step ST-B6.

In other words, none of the base stations operating in the same GEO can provide SMS, the control process returns to Step ST-A5, whereby Steps ST-A6, ST-A10 and ST-A11 (Step ST-B8).

As FIG. 5 illustrates, the mobile radio communication apparatus recognizes that the user has made an SMS request. In this case, the controller 40 finds that the base station seized, which has SID44, cannot offer SMS, from the information contained in the system table. The controller 40 searches the system table for any other base station which operates in the same GEO including the base station of SID44 and which offers SMS, in accordance with the priorities assigned to the base stations operating in that GEO.

As a result, the controller 40 finds that the base station that has SID4002 offering SMS. The controller 40 refers to the system table, confirming that the base station having SID4002 belongs to acquisition index “2”. The controller 40 then scans an analog A type frequency that corresponds to the acquisition index “2” shown in FIG. 3. The mobile radio communication apparatus tries to seize the base station having SID4002. When the apparatus seizes this base station, it automatically transmits an SMS-request signal to the base station.

A second embodiment of the present invention will be described.

In the mobile radio communication apparatus corresponding to the first embodiment, the control process is carried out to receive SMS (short-message service) from a base station. The invention is not limited to the first embodiment. The invention may be applied to another type of a mobile radio communication apparatus that can receive wireless application protocol (WAP) service or interactive communication service. The second embodiment may receive the WAP service to download and to browse the information available on Internet and display the information. Alternatively, it may receive interactive communication service to receive data from base stations and transmit data to the base stations. In either case, it is sufficient for the system table to store the SIDs of base stations that offer the service, as is illustrated in FIG. 4. Hence, the second embodiment can seize a base station that offers the WAP service or the interactive communication service if the user makes a request for the service.

In the system table shown in FIG. 4, the priorities assigned to the base stations are stored, each associated with the SID of a base station, so that the priorities of the base stations may be identified with their SIDs. Instead, the priorities of the base stations may be identified with program functions, which the controller can recognize.

Moreover, the service that a mobile radio communication apparatus according to this invention can receive includes data communication service, in addition to telecommunication, SMS service and WAP service.

As has been described, the mobile radio communication apparatus according to this invention stores system ID numbers, priority data items corresponding to the system ID numbers and assigned to base stations, each to be used to seize one base station, and service information representing the types of services the base station offer. The user inputs a request for a desired type of service into the apparatus while the apparatus remains in an idle state, thereby seizing the base station having the highest priority. If the user inputs request for a service such as SMS, WAP, and the base station thus seized does not offer the service of the desired type, the system ID numbers and the service information are referred to. The apparatus can therefore seize one of other base stations which offer the service of the desired type.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A mobile radio communication apparatus for use in a mobile radio communication system which includes base stations, mobile radio communication apparatuses to be connected to the base stations over radio channels, and in which each of the base stations broadcasts a system ID number for identifying the base station, said apparatus comprising:
memory means for storing system ID numbers, priority data items associated with the system ID numbers and representing priorities assigned to the base stations, each to be used to seize one base station, and information representing types of service the base stations offer in a geographical area in which the base stations are operating;
receiving means for receiving the broadcasted system ID number;
first seizing means for seizing one of the base stations operating in the geographical area and having one of the received system ID numbers, in accordance with the priority data items, and for setting the apparatus in an idle state;
input means for inputting a user's request for a desired type of service while the apparatus remains in the idle state;
decision means for referring to the contents of said memory means when the user's request is input to said input means, thereby determining whether the base station seized is offering the type of service the user has requested; and
second seizing means for seizing, based on the priority data items, one of the base stations offering the desired type of service in the geographical area including the base station seized by said first seizing means, when said decision means determines that the base station seized by said first seizing means does not offer the desired type of service.

2. The apparatus according to claim 1, wherein when said second seizing means has failed to seize the base station of the lowest priority, said second seizing means receives a system ID number, specifies a geographical area associated with the received system ID number, seizes one of the base stations operating in the specified geographical area, and sets the apparatus into the idle state.

3. The apparatus according to claim 1, wherein said memory means stores frequency data items associated with the respective base stations, for use in seizing base stations, and said second seizing means seizes a base station offering the user's request service type in accordance with the frequency data items when said decision means determines that the base station seized by said first seizing means is not offering the type of service the user has requested.

4. The apparatus according to claim 3, further comprising transmitting means for transmitting a service request signal generated from the user's request, to the base station seized by said second seizing means.

5. A mobile radio communication apparatus for use in a mobile radio communication system which includes base stations, mobile radio communication apparatuses to be connected to the base stations over radio channels, and in which each of the base stations broadcasts a system ID number for identifying the base station, said apparatus comprising:
memory means for storing system ID numbers and information that is associated with the system ID numbers and represents types of service the base stations offer, in a geographical area in which the base stations are operating;
receiving means for receiving the broadcasted system ID number;
first seizing means for seizing one of the base stations operating in the geographical area and having one of the received system ID numbers, which has prescribed priority, and setting the apparatus in an idle state;
input means for inputting a user's request for a desired type of service while the apparatus remains in the idle state;
decision means for referring to the contents of said memory means when the user's request is input to said input means, thereby determining whether the base station seized is offering the type of service the user has requested; and
second seizing means for seizing one of the base stations offering the desired type of service in the geographical area including the base station seized by said first seizing means, when said decision means determines that the base station seized by said first seizing means does not offer the desired type of service.

6. The apparatus according to claim 5, wherein said memory means stores frequency data items associated with the respective base stations, for use in seizing base stations, and said second seizing means seizes a base station offering the user's request service type in accordance with the frequency data items when said decision means determines that the base station seized by said first seizing means is not offering the type of service the user has requested.

7. The apparatus according to claim 5, wherein when said second seizing means has failed to seize the base station of the lowest priority, said second seizing means receives a system ID number, specifies a geographical area associated with the received system ID number, seizes one of the base stations operating in the specified geographical area, and sets the apparatus into the idle state.

8. A mobile radio communication apparatus for use in a mobile radio communication system which includes base stations, mobile radio communication apparatuses to be connected to the base stations over radio channels, and in which each of the base stations broadcasts a system ID number for identifying the base station, said apparatus comprising:
memory means for storing system ID numbers, priority data items associated with the system ID numbers and representing priorities assigned to the base stations, each to be used to seize one base station, and information representing types of service the base stations offer in a geographical area;
first seizing means for receiving one of the system ID numbers broadcasted from the base stations, in accordance with the priority data items stored in said memory means, for seizing one of the base stations to which the system ID number received is assigned, and for setting the apparatus in an idle state;
input means for inputting a user's request for a desired type of service while the apparatus remains in the idle state;
decision means for referring to the contents of said memory means when the user's request is input to said input means, thereby determining whether the base station seized is offering the type of service the user has requested; and
second seizing means for seizing one of the base stations offering the desired type of service, when said decision means determines that the base station seized by said first seizing means does not offer the desired type of service.

9. The apparatus according to claim 8, wherein said memory means stores frequency data items associated with the respective base stations, for use in seizing base stations, and said second seizing means seizes a base station offering the user's request service type in accordance with the frequency data items when said decision means determines that the base station seized by said first seizing means is not offering the type of service the user has requested.

10. The apparatus according to claim 8, wherein when said second seizing means has failed to seize the base station of the lowest priority, said second seizing means receives a system ID number, specifies a geographical area associated with the received system ID number, seizes one of the base stations operating in the specified geographical area, and sets the apparatus into the idle state.

11. A mobile radio communication apparatus for use in a mobile radio communication system which includes base stations, mobile radio communication apparatuses to be connected to the base stations over radio channels, and in which each of the base stations broadcasts a control signal with a system ID number for identifying the base station, said apparatus comprising:
memory means for storing system ID numbers, priority data items representing priorities of the base stations and geographical area data items representing areas in which the base stations are located, said system ID numbers, said priority data items and said geographical area data items being mutually associated;
receiving means for receiving the broadcasted control signal, the signal including the system ID number assigned to a base station;
detecting means for detecting the system ID number, from the received control signals;
area-designating means for designating, based on the detected system ID number, a geographical area data item representing an area in which the base station connected to the mobile radio communication apparatus is located;
seizing means for detecting the system ID number assigned to the base station having a higher priority in the area, based on the geographical area data item designated by said area-designating means, for seizing the base station, and for setting the apparatus in an idle state;
input means for inputting a user's request for a desired type of service while the apparatus remains in the idle state;
decision means for referring to the contents of said memory means when the user's request is input to said input means, thereby determining whether the base station seized is offering the type of service the user has requested; and
control means for causing said seizing means to seize, based on the priority data items, one of the base stations offering the desired type of service in the geographical area including the base station seized by said seizing means, when said decision means determines that the base station seized by said seizing means does not offer the desired type of service.

12. The apparatus according to claim 11, further comprising transmitting means for transmitting a service request signal generated from the user's request, to the base station seized by said seizing means.

13. The apparatus according to claim 11, wherein when said second seizing means has failed to seize the base station of the lowest priority, said seizing means receives a system ID number, specifies a geographical area associated with the received system ID number, seizes one of the base stations operating in the specified geographical area, and sets the apparatus into the idle state.

14. A mobile radio communication apparatus for use in a mobile radio communication system which includes base stations, mobile radio communication apparatuses to be connected to the base stations over radio channels, and in which each of the base stations broadcasts a system ID number for identifying the base station, said apparatus comprising:
setting means for seizing one of the base stations in accordance with the broadcasted system ID numbers and setting the apparatus in an idle state;
input means for inputting a user's request for a desired type of service while the apparatus remains in the idle state; and
control means for causing said setting means to seize a base station offering the desired type of service which is described in the user's request input to said input means.

15. The apparatus according to claim 14, further comprising transmitting means for transmitting a service request signal generated from the user's request, to the base station seized based on said control means.

16. The apparatus according to claim 14, wherein said setting means comprises:
memory means for storing system ID numbers, priority data items representing priorities of the base stations and geographical area data items representing areas in which the base stations are located, said system ID numbers, said priority data items and said geographical area data items being mutually associated;
receiving means for receiving control signals broadcasted from the base stations, each including the system ID number assigned to a base station;
detecting means for detecting the system ID numbers, from the received control signals;
area-designating means for designating, based on the detected system ID number, a geographical area data item representing an area in which the base station connected to the mobile radio communication apparatus is located; and
seizing means for detecting the system ID number assigned to the base station having a higher priority in the area, based on the geographical area data item designated by said area-designating means, for seizing the base station, and for setting the apparatus in an idle state.

17. The apparatus according to claim 16, wherein said control means comprises:
decision means for referring to the contents of said memory means when the user's request is input to said input means, thereby determining whether the base station seized is offering the type of service the user has requested; and
seizing means for seizing, based on the priority data items, one of the base stations offering the desired type of service in the geographical area including the base station seized, when said decision means determines that the base station seized does not offer the desired type of service.

18. The apparatus according to claim 17, wherein when said second seizing means has failed to seize the base station of the lowest priority, said seizing means receives a system ID number, specifies a geographical area associated with the received system ID number, seizes one of the base stations operating in the specified geographical area, and sets the apparatus into the idle state.
